(19) United States
(12) Patent Application Publication
(10) Pub. No.: US 2012/0160220 A1
(43) Pub. Date: Jun. 28, 2012

(54) Device for ventilating and aerating a fuel tank

(75) Inventor: Harald Hagen, Creussen (DE)

(73) Assignee: Audi AG, Ingolstadt (DE)

(21) Appl. No.: 13/328,288

(22) Filed: Dec. 16, 2011

(30) Foreign Application Priority Data
Dec. 21, 2010 (DE) 10 2010 055 311.5

(51) Int. Cl. F02M 33/02

(52) U.S. Cl. 123/520

(57) ABSTRACT

A device for ventilating and aerating a fuel tank, in particular a fuel tank of an internal combustion engine of a motor vehicle, includes an activated carbon filter, a controllable tank shut-off valve and two tank pressure control valves. One of the tank pressure control valves opens in response to an overpressure in the fuel tank, and the other one of the tank pressure control valves of opens in response to a negative pressure in the fuel tank. In order to reduce the amount of volatile hydrocarbons escaping into the environment from the tank shut-off valve and the tank pressure control valves, at least the two tank pressure control valves and preferably the two tank pressure control valves and the tank shut-off valve are arranged inside the fuel tank.

The invention relates to a device for ventilating and aerating a fuel tank according to the preamble of claim 1.

Modern motor vehicles are equipped with a device for ventilating and aerating their fuel tank. On one hand, this device allows a gas mixture which is displaced by the fuel during refueling, to escape from the interior of the fuel tank and on the other hand, in the case of a greater rise or drop of ambient temperatures, prevents an undesired formation of overpressure or negative pressure in the pressure-tight closed tank as a result of the evaporation caused by the rise of temperature or, respectively, condensation of fuel vapors caused by the drop of temperature. The device normally includes a controllable tank shut-off valve, for example an electromagnetic valve, two mechanical tank pressure control valves in the form of an overpressure valve and a negative pressure valve, which are mostly configured as bypass valves of the tank shut-off valve, as well as an activated carbon filter which is arranged between the valves and the environment and has the purpose to prevent an undesired escape of hydrocarbons from the tank into the atmosphere or the environment when the fuel tank is ventilated. The tank shut-off valve is normally closed and is opened during refueling of the fuel tank to conduct the gas mixture, which is displaced by the fuel, out of the gas or headspace of the fuel tank. Furthermore, the tank shut-off valve is usually opened during operation of the internal combustion engine under the control of an engine control unit of the internal combustion engine, when a pressure in the fuel tank, which is measured by a tank pressure sensor, exceeds an adjustable overpressure threshold or an adjustable negative pressure threshold, to avoid excessive stress on the fuel tank. Because the tank shut-off valve can normally not be controlled when the internal combustion engine stands still, the pressure in the interior of the fuel tank is limited in this operating state by means of the two tank pressure control valves. In this case, the overpressure valve opens automatically when for example in the case of rising ambient temperatures or during a residual heating period after turning off the engine, the fuel in the interior of the fuel tank evaporates and as a result the pressure in the fuel tank rises above the opening pressure of the overpressure valve, which opening pressure lies above the overpressure threshold value, while the negative pressure valve opens automatically, when for example in the case of falling ambient temperatures fuel condenses in the interior of the fuel tank and as a result, the pressure in the fuel tank falls below an opening pressure of the negative pressure valve, which opening pressure lies below the negative pressure threshold. The gas mixture which leaks from the fuel tank during ventilation of the latter is conducted through the activated carbon filter to adsorb the volatile hydrocarbons (HC) which are contained in the gas mixture, so that only purified air is released into the environment.

In known devices of this type the tank shut-off valve and the two tank pressure control valves are usually combined into a valve unit or valve assembly which, like the activated carbon filter, is also arranged outside of the fuel tank for better accessibility. The valve unit or valve assembly normally has a housing with a tank connection and a filter connection, which are connected to a line which leads to the fuel tank or the activated carbon filter, respectively. The housing of the valve unit or valve assembly is mostly assembled from multiple parts, so that in spite of sealing the parting lines, a complete tightness cannot be ensured. The same applies to the connections between the tank connection and the filter connection of the housing and the line which leads to the fuel tank or the activated carbon filter, respectively, so that a leaking of small amounts of volatile hydrocarbons (HC) from the valve unit or valve assembly cannot be reliably prevented. In the case of a separation of the tank shut-off valve and the two tank pressure control valves, the amount of volatile hydrocarbons (HC) leaking from the valves would be even larger because of the higher number of parting lines and connections.

Because the statutory provisions for avoiding fuel emissions into the environment are made ever stricter, it is predictable that the leaking of smaller amounts of hydrocarbons (HC) from valves of devices of the aforementioned type into the environment will also no longer be permissible.

Taking the foregoing into account, the invention is based on the object to improve a device of the aforementioned type so that the amount of volatile hydrocarbons leaking from its valves into the environment can be reduced.

According to the invention this object is solved, in that at least the two tank pressure control valves and preferably the two tank pressure control valves as well as the tank shut-off valve are arranged in the interior of the fuel tank. The invention is based on the idea that by relocating the valves into the interior of the fuel tank the hydrocarbons leaking from these valves are released into the closed fuel tank and not into the environment. No new valves have to be developed, because the existing valves are already made of materials which are resistant to fuel vapors.

In a first embodiment, the tank shut-off valve and the two tank pressure control valves are not, as previously, combined to a single valve unit or valve assembly, but the tank shut-off valve on one hand and the two tank pressure control valves on the other hand are mounted separate from each other, i.e. the tank shut-off valve outside of the fuel tank and the two tank pressure control valves inside of the fuel tank.

In this case, the tank shut-off valve which is located outside the fuel tank is, as before, expediently connected to an activated carbon filter which is also located outside the fuel tank, by a line which extends outside the fuel tank, while the two tank pressure control valves are preferably connected by a line which leads out of the fuel tank, to the line which leads from the tank shut-off valve to the activated carbon filter, or alternatively also directly to the activated carbon filter, for example when the latter is disposed directly on the fuel tank.

The two tank pressure control valves which are arranged in the interior of the fuel tank are expediently arranged in a gas or headspace of the motor vehicle, which is not filled with fuel when the fuel tank is refueled. Advantageously, the two tank pressure control valves, however, do not communicate directly with the gas or headspace, but via a so-called liquid trap with which liquid fuel, such as condensate, can be separated from the gas mixture which leaks from the overpressure valve, before reaching the opened overpressure valve, so that liquid fuel can neither accumulate in the overpressure valve nor be carried along as far as into the activated carbon filter.

The two tank pressure control valves are advantageously combined in parallel connection into a valve unit or valve assembly with a common inlet or tank connection and a common outlet or filter connection, wherein the inlet is expediently connected to the liquid trap and the outlet is connected to the line which leads out of the tank. The two tank pressure control valves are preferably purely mechanical valves, each having two chambers which are separated by a membrane, wherein the chambers each communicate in pairs with the liquid trap through the inlet or with the line which leads out of the fuel tank through the outlet, respectively.

In a further preferred embodiment, the pressure in the fuel tank is controlled exclusively by means of the two tank pressure control valves, not only as previously when the internal combustion engine stands still but also during operation of the internal combustion engine, while the tank shut-off valve remains closed during operation of the internal combustion engine and is only opened when refueling the fuel tank. The tank shut-off valve, which is arranged outside the fuel tank, is advantageously connected to the gas or headspace of the fuel tank or to a liquid trap which communicates with the gas or headspace, wherein this line preferably extends outside of the fuel tank and leads into the interior of the gas or headspace or the liquid trap, respectively, through a closing lid of an opening on the top side of the fuel tank. Because during refueling the motor vehicle always stands on a level surface, a roll-over valve between the gas or headspace of the fuel tank and the line is not needed.

As an alternative, it is also possible, however, to control the pressure in the fuel tank as before by means of the tank shut-off valve, by opening the latter in a pulsed manner when the pressure measured by a tank pressure sensor exceeds a predetermined overpressure threshold or falls below a predetermined negative pressure threshold. The tank shut-off valve is controlled in both cases by a control, preferably the engine control unit of the internal combustion engine. Because in this case it cannot be excluded, however, that the tank shut-off valve happens to be open in the event of an accident of the motor vehicle, at least one roll-over valve between the gas or headspace of the fuel tank and the line is required.

In a preferred second embodiment, the tank shut-off valve as well as the two tank pressure control valves are mounted within the gas or headspace of the fuel tank and are preferably combined. into a single valve unit or valve assembly. Compared to the previously described embodiment, this embodiment has the advantage that fuel vapors which leak from the tank shut-off valve also cannot reach the environment, it requires however a somewhat greater space in the interior of the fuel tank. Advantageously, in this case the valve unit or valve assembly also does not communicate directly with the gas or headspace out of the two tank pressure control valves and the tank shut-off valve, but rather with a liquid trap, with which liquid fuel can be separated from a gas mixture which flows out of the gas or headspace through the valve unit or valve assembly to the activated carbon filter, so that on one hand no condensate accumulates inside the valve unit or valve assembly, and on the other hand no liquid fuel is carried along into the activated carbon filter.

The basic construction of the mechanical tank pressure control valves is the same irrespective of the position of the tank shut-off valve: Each tank pressure valve surrounds advantageously two chambers which are separated by a membrane, one of which chambers communicates with the tank connection and the other one with the filter connection. The membrane has an opening and is pressed by a spring around the opening against the free end of a pipe socket which traverses one of the chambers and leads into the other chamber in which the spring is located. The connection between the two chambers and the tank connection or the filter connection, respectively, is inverted in the overpressure valve and the negative pressure valve. In the overpressure valve, the chamber which surrounds the pipe socket communicates with the fuel tank, and the chamber which is equipped with the spring communicates with the activated carbon filter. When an overpressure forms in the fuel tank which exceeds the opening pressure of the overpressure valve, the membrane is lifted against the force of the spring from the pipe socket, so that the two chambers are connected to each other. In the negative pressure valve, the chamber equipped with the spring communicates with the fuel tank, and the chamber surrounding the pipe socket communicates with the activated carbon filter. When a negative pressure forms in the fuel tank which exceeds the opening pressure of the negative pressure valve, the membrane is lifted by the negative pressure from the pipe socket against the force of the spring, so that the two chambers are also connected to each other.

In the following, the invention is explained in more detail by way of several exemplary embodiments shown in the drawing. It is shown in

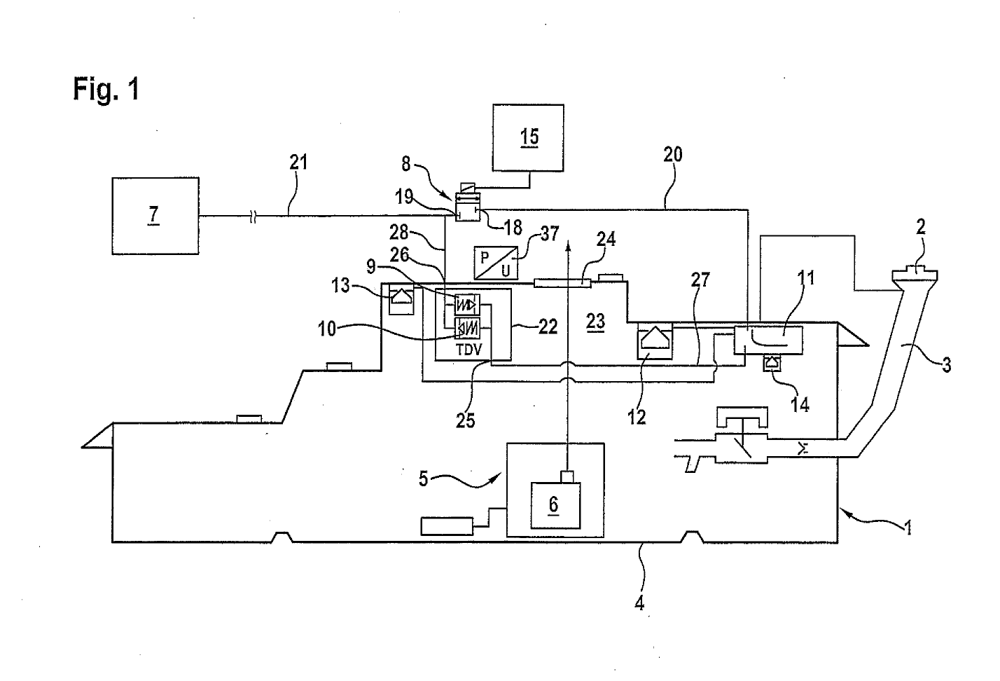

FIG. 1 a schematic view of a fuel tank with a ventilation device, which includes a tank shut-off valve located outside the fuel tank and two tank pressure control valves located inside the fuel tank;

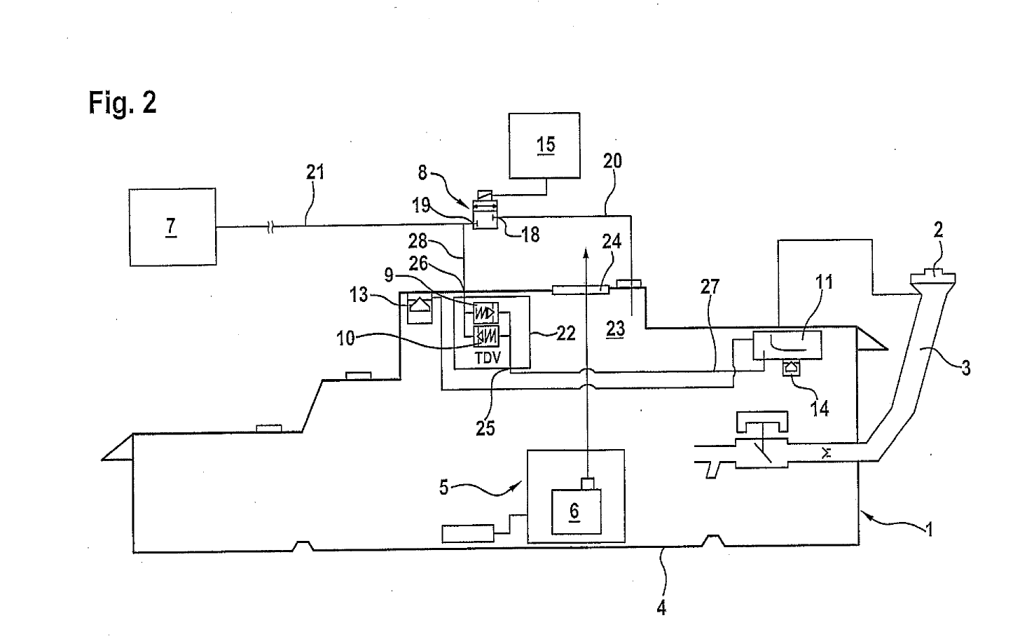

FIG. 2 a schematic view of a fuel tank with a modified ventilation and aeration device, which also includes a tank shut-off valve located outside the fuel tank and two tank pressure control valves located inside the fuel tank;

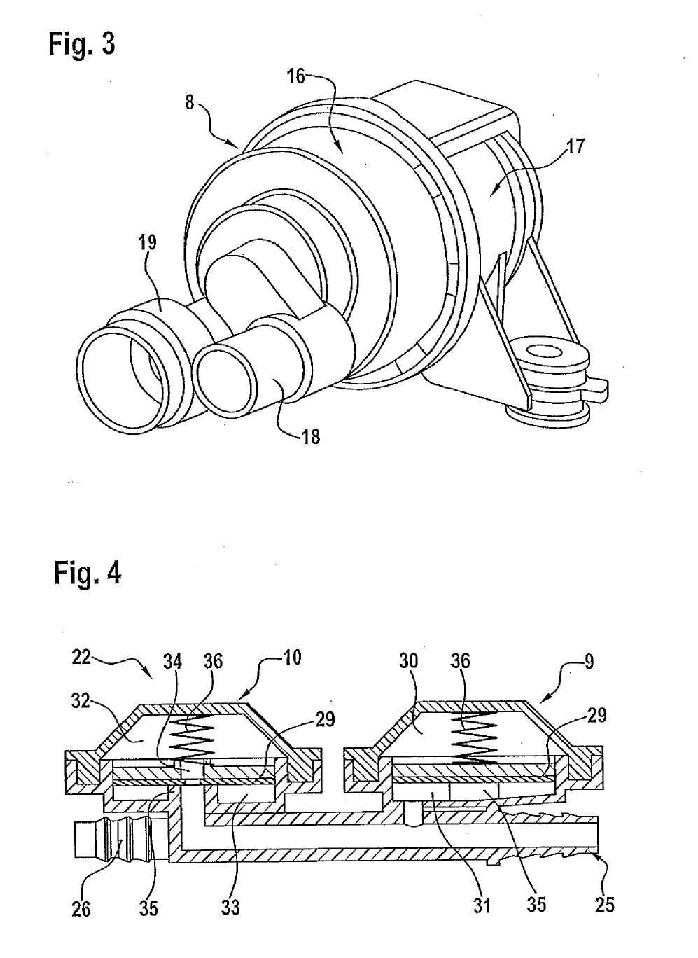

FIG. 3 a perspective view of the tank shut-off valve;

FIG. 4 a longitudinal sectional view of the two tank pressure control valves;

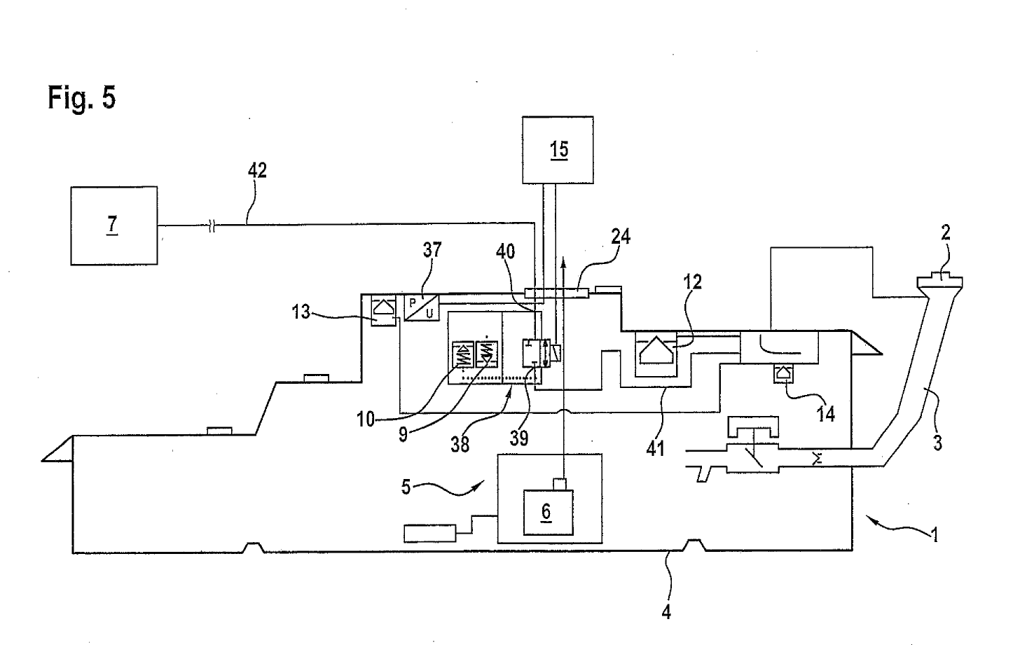

FIG. 5 a schematic view of the fuel tank with a further, modified ventilation and aeration device, in which the tank shut-off valve as well as the tank pressure control valves are located inside of the fuel tank.

The fuel tank 1 of a motor vehicle shown in the drawing is a pressure tight fuel tank 1, produced by blow molding from a gas- and liquid-tight sandwich material. For refueling, the fuel tank 1 has a filler neck 3 which can be closed by a tank lid 2. Located near the bottom of the fuel tank 1 is a conveyor unit 5 with a fuel pump 6 which is submerged in the fuel. The fuel tank 1 is equipped with a ventilation device, which includes an activated carbon filter 7, a tank shut-off valve 8, two tank pressure control valves 9, 10, a liquid trap 11 and optionally one or multiple roll-over valves 12, 13, 14.

The activated carbon filter which is arranged outside of the fuel tank 1 prevents volatile hydrocarbons (HC) from reaching the environment when the fuel tank 1 is vented, and for this purpose has a filling made of activated carbon, which adsorbs volatile hydrocarbons (HC). When the activated carbon filter 7 is loaded with volatile hydrocarbons, it is regenerated by aspirating ambient air through the activated carbon filter 7 into an intake tract (not shown) of the internal combustion engine, to flush the filter 7 and burn the volatile hydrocarbons in the combustion chambers of the internal combustion engine.

In the fuel tanks 1 shown in the FIGS. 1 and 2, the tank shut-off valve 8 is arranged outside of the fuel tank 1, while the two tank pressure control valves 9 and 10 are arranged in the interior of the fuel tank 1.

The tank shut-off valve 8 is an electromagnetic valve, which is normally closed and can be opened in a pulsed manner under the control of an engine control unit 15 of the internal combustion engine. As best shown in FIG. 3, the tank shut-off valve 8 includes a valve part 16 and a valve actuating part 17. The valve part 16 includes a valve seat and a valve member (not shown) which is movable relative to the valve seat, as well as a tank connection 18 and a filter connection 19. The valve actuating part 17 contains an electromagnetic coil and an anchor (not shown) acting on the valve member. When the electromagnetic coil is excited, the anchor lifts the valve member from the valve seat, whereupon the two connections 18, 19 communicate with one another. As best shown in FIGS. 1 and 2 the tank connection 18 is connected to the interior of the fuel tank 1 through a line 20 which extends outside of the fuel tank 1, while the filter connection 19 is connected to the activated carbon filter 7 through a line 21 which also extends outside of the fuel tank 1.

The two tank pressure control valves 9, 10 are a purely mechanical overpressure valve 9 and a purely mechanical negative pressure valve 10 which in parallel connection are combined into a valve unit or valve assembly 22. The valve unit or valve assembly 22 is disposed in a head- or gas room 23 of the fuel tank 1 above the highest fuel level, wherein it is preferably mounted on or near a closing lid 24, which closes an opening in the top side of the fuel tank 1, so that it is easily accessible if needed. The valve unit or valve assembly 22 has a tank connection 25 and a filter connection 26. A line 27 extends from the tank connection 25 through the interior of the fuel tank 1 to the liquid trap 11, while a line 28 extends from the filter connection 26 up to the line 21, into which it leads behind the tank shut-off valve 8.

As best shown in FIG. 4, the two tank pressure control valves 9, 10 each have two chambers 30, 31; 32, 33, which are separated by a membrane 29, of which one chamber 31; 32 communicates with the tank connection 25 and one chamber 30; 33 with the filter connection 26. The membrane 29 of each valve 9, 10 is provided with an opening and when the valve 9, 10 is closed, rests around the opening 34 on a cylindrical pipe socket 35, through which in the overpressure valve 10 the negative pressure chamber 32 communicates with the fuel tank 1, and in the overpressure valve 9 the other chamber 30 communicates with the activated carbon filter 7. The membrane 29 is pressed against the free upper end of the pipe socket 35 by a spring 36 and ensures that the two chambers 30, 31; 32, 33 do not, i.e. not normally, communicate with one another when the valve 9, 10 is closed. When the pressure in the fuel tank 1 falls below an opening pressure of the negative pressure valve 10, the membrane 29 of the negative pressure valve 10, as a result of the negative pressure in the negative pressure chamber 32 which communicates with the tank connection through the opening 34 and the pipe socket, is lifted from the pipe socket 35 against the force of the spring 36, whereby the two chambers 32, 33 are connected by opening of the valve 10. When the pressure in the fuel tank rises above an opening pressure of the overpressure valve 9, the membrane 29 of the overpressure valve 9 is lifted by the pressure in the overpressure chamber 31 from the pipe socket 35 against the force of the spring 36, whereby the two chambers 30, 31 are also connected to one another by opening of the valve 9.

The liquid trap 11, which is arranged in the gas or headspace of the fuel tank 1 and which borders on the top side of the fuel tank 1, has the purpose to prevent that when venting the fuel tank 1, liquid fuel is carried along by the gas mixture which leaks from the interior of the fuel tank 1, up to the activated carbon filter 7. The roll-over valves 12, 13, 14 have the purpose to prevent a release of liquid fuel from the fuel tank 1, when the motor vehicle, for example in the event of an accident, slopes excessively or overturns. The construction of a liquid trap 11 or roll-over valves 12, 13, 14 is known per se, and is therefore not further described.

In the fuel tank 1 shown in FIG. 1, the tank shut-off valve 8 is connected to the liquid trap 11 through the line 20. During operation of the internal combustion engine, the tank shut-off valve 8 is opened in a pulsed manner buy the engine control unit 15 of the internal combustion engine, when a pressure in the fuel tank 1 measured by a tank pressure sensor 37, exceeds an adjustable overpressure threshold or falls below an adjustable negative pressure threshold. In contrast, when the internal combustion engine stands still, the pressure in the interior of the fuel tank 1 is kept within a predetermined pressure range by means of the two tank pressure control valves 9, 10, whose upper limit lies somewhat above the overpressure threshold, while its lower limit lies somewhat below the negative threshold. The opening pressure of the overpressure valve 9 corresponds to the upper limit of the predetermined pressure range, so that the overpressure valve 9 opens automatically when the pressure in the fuel tank 1, for example in the case of rising ambient temperatures or during a residual heating period after turning off the internal combustion engine, reaches or exceeds the upper limit of the predetermined pressure range, as a result of evaporation of fuel in the interior the fuel tank 1. The opening pressure of the negative pressure valve 10 corresponds to the lower limit of the predetermined pressure range, so that the negative pressure valve 10 opens automatically, when for example in the case falling ambient temperatures, fuel in the interior the fuel tank condenses and as a result the pressure in the fuel tank 1 reaches or falls below the lower limit of the predetermined pressure range. The gas mixture which leaks from the fuel tank 1 when the tank shut-off valve 8 or the overpressure valve 9, respectively, is open is conducted to the activated carbon filter 7 through the line 21 or 21 and 28, respectively, to adsorb the volatile hydrocarbons (HC) which are contained in the gas mixture, so that only purified air is released into the environment.

In the fuel tank 1 shown in FIG. 2 on the other hand, the tank shut-off valve 8 remains closed during operation of the internal combustion engine and is only opened during refueling of the fuel tank 1. The pressure in the interior of the fuel tank 1 is kept within a predetermined pressure range exclusively by means of the two mechanical tank pressure control valves 9, 10. This pressure range is delimited upwards by an overpressure threshold value which is determined by the construction of the overpressure valve 9 and downwards by a negative pressure threshold value which is determined by the design of the negative pressure valve 10. The overpressure valve 9 opens automatically when the pressure in the fuel tank 1 reaches or exceeds the overpressure threshold value. The negative pressure valve 10 opens automatically when the pressure in the fuel tank 1 reaches or falls below the negative pressure threshold value. The pressure range is kept relatively narrow, so that the fuel tank 1 is not exposed to peak loads. The line 20 which leads from the tank shut-off valve 8 to the fuel tank 1, instead of into the liquid trap 11, leads directly into the gas or headspace 23 of the fuel tank 1. Because the motor vehicle 1 is always positioned on a level ground during refueling, at least one of the roll-over valves 12, 13, 14 is not needed in this fuel tank 1 or in this mode, respectively, which is indicated in FIG. 2 by the missing roll-over valve 12 between the liquid trap 11 and the gas or headspace 23.

In the fuel tank 1 shown in FIG. 5, the tank shut-off valve 8 together with the two tank pressure valves 9 and 10 is arranged in the interior of the fuel tank. The tank shut-off valve 8 and the two tank pressure control valves 9 and 10 are combined to a valve unit or a valve assembly 38, wherein the two tank pressure control valves 9, 10 are arranged as bypass valves connected in parallel to the tank shut-off valve 8. The valve unit or valve assembly 38 has a common tank connection 39 and a common filter connection 40. The tank connection 39 is connected to the liquid trap 11 through a line 41 which extends within the fuel tank 1, while the filter connection 40 is connected to the activated carbon filter 7 through a line 42 which leads out of the fuel tank 1.

As described above, the tank shut-off valve 8 can optionally be only opened during refueling of the fuel tank 1 by adopting the pressure control from the tank pressure control valves 9 and 10 during standstill as well as during operation of the internal combustion engine, or the tank shut-off valve 8 can also be used during operation of the internal combustion engine for the pressure regulation.

In all fuel tanks 1, the filler neck 3 is connected to the liquid trap 11 through an on-board diagnostic line 43, so that the absence of the tank lid 2 can be detected, to prevent pressure compensation and the leakage of hydrocarbons through the filler neck 3. Because no overpressure or negative pressure can form in the interior of the fuel tank 1 when the tank lid 2 is absent, the absence of the tank lid 2 can be detected by analyzing the signals of the tank pressure sensor 37.

### LIST OF REFERENCE SIGNS

1 fuel tank
2 tank lid
3 filler neck
4 bottom
5 conveyor unit
6 fuel pump
7 activated carbon filter
8 tank shut-off valve
9 overpressure valve
10 negative pressure valve
11 liquid trap
12 roll-over valve
13 roll-over valve
14 roll-over valve
15 engine control unit
16 valve part tank shut-off valve
17 valve actuating part tank shut-off valve
18 tank connection tank shut-off valve
19 filter connection tank shut-off valve
20 line
21 line
22 valve unit or valve assembly
23 head or gas space
24 closing lid
25 tank connection valve unit or valve assembly
26 filter connection valve unit or valve assembly
27 line
28 line
29 membrane
30 chamber
31 overpressure chamber
32 negative pressure chamber
33 chamber
34 opening
35 pipe socket
36 spring
37 tank pressure sensor
38 valve unit or valve assembly
39 tank connection valve unit or valve assembly
40 filter connection valve unit or valve assembly
41 line
42 line
43 on-board diagnostic line

1.-15. (canceled)

16. A device for ventilating and aerating a fuel tank of an internal combustion engine, comprising
an activated carbon filter;
a controllable tank shut-off valve; and
two tank pressure control valves, one of the two tank pressure control valves configured to open in response to a negative pressure in the fuel tank, and the other one of the two tank pressure control valves configured to open in response to an overpressure in the fuel tank, wherein at least one of the two tank pressure control valves is arranged inside the fuel tank.

17. The device of claim 16, for use in an internal combustion engine of a motor vehicle.

18. The device of claim 16, wherein the activated carbon filter and the tank shut-off valve are arranged outside the fuel tank and the two tank pressure control valves are arranged inside the fuel tank.

19. The device of claim 18, wherein the two tank pressure control valves are connected to one another in parallel to form a valve unit or valve assembly having a common tank connection and a common filter connection.

20. The device of claim 18, further comprising a line routed from the two tank pressure control valves within the fuel tank to feed into the activated carbon filter or another line extending downstream of the tank shut-off valve between the tank shut-off valve and the activated carbon filter.

21. The device of claim 16, wherein the two tank pressure control valves are arranged above a highest fuel level in a gas or headspace of the fuel tank.

22. The device of claim 21, further comprising a liquid trap for separating liquid fuel, wherein the two tank pressure control valves communicate with the gas or headspace of the fuel tank via the liquid trap.

23. The device according of claim 16, wherein the tank shut-off valve is connected by a line to a gas or headspace of the fuel tank.

24. The device according of claim 16, further comprising a liquid trap for separating liquid fuel, wherein the tank shut-off valve is connected to a gas or headspace of the fuel tank via the liquid trap.

25. The device of claim 23, characterized by the absence of a roll-over valve between the gas or headspace of the fuel tank and the line.

26. The device of claim 16, wherein the tank shut-off valve and the two tank pressure control valves are arranged inside the fuel tank.

27. The device of claim 26, wherein the tank shut-off valve and the two tank pressure control valves are arranged above a highest fuel level in the gas or headspace of the fuel tank.

28. The device of claim 26, wherein the tank shut-off valve and the two tank pressure control valves are connected in parallel to form a valve unit or valve assembly having a common tank connection and a common filter connection.

29. The device of claim 28, wherein the activated carbon filter is arranged outside the fuel tank, and further comprising a liquid trap for separating liquid fuel, said tank connection being connected to the liquid trap by a line arranged inside the fuel tank and to the activated carbon filter by another line extending out of the fuel tank.

30. The device of claim 22, further comprising at least one roll-over valve, said liquid trap communicating with the gas or headspace via the at least one roll-over valve.

31. The device of claim 24, further comprising at least one roll-over valve, said liquid trap communicating with the gas or headspace via the at least one roll-over valve.

32. The device of claim 29, further comprising at least one roll-over valve, said liquid trap communicating with a gas or headspace of the fuel tank via the at least one roll-over valve.

33. The device of claim 16, wherein, during operation of the internal combustion engine, the tank shut-off valve remains closed and a pressure in the fuel tank is controlled only by the two tank pressure control valves.

34. The device of claim 16, wherein the two tank pressure control valves are purely mechanical valves, each having two chambers separated by a membrane, two chambers of the tank pressure control valves communicating with an interior of the fuel tank and two chambers of the tank pressure control valves communicating with an interior of the activated carbon filter.
